(19) United States
(12) Patent Application Publication
(10) Pub. No.: US 2024/0199796 A1
(43) Pub. Date: Jun. 20, 2024

(54) HIGH HEAT RESISTANT AND TRANSPARENT POLYETHYLENE TEREPHTHALATE (PET) COPOLYESTER AND MANUFACTURING METHOD THEREOF

(71) Applicant: NAN YA PLASTICS CORPORATION, TAIPEI (TW)

(72) Inventors: Te-Chao Liao, Taipei (TW); Han-Ching Hsu, Taipei (TW); Chen-Wei Chang, Taipei (TW)

(73) Assignee: NAN YA PLASTICS CORPORATION, TAIPEI (TW)

(21) Appl. No.: 18/150,760

(22) Filed: Jan. 5, 2023

(30) Foreign Application Priority Data
Dec. 15, 2022 (TW) 111148311

(51) Int. Cl. C08G 63/183; C08G 63/87

(52) U.S. Cl. CPC C08G 63/183; C08G 63/87

(57) ABSTRACT

A polyethylene terephthalate (PET) copolyester and a manufacturing method thereof are provided, including the following steps. A dispersion slurry including a talcum powder is formulated. Terephthalic acid and ethylene glycol are mixed, and the dispersion slurry and a side group ester compound are introduced to perform a transesterification reaction and form bis-2-hydroxylethyl terephthalate. Afterwards, a prepolymerization reaction and a polycondensation reaction are carried out to form a polyethylene terephthalate copolyester.

### CROSS-REFERENCE TO RELATED APPLICATION

This application claims the priority benefit of Taiwan application serial no. 111148311, filed on Dec. 15, 2022. The entirety of the above-mentioned patent application is hereby incorporated by reference herein and made a part of this specification.

### BACKGROUND

### Technical Field

The present disclosure relates to a polyethylene terephthalate (PET) copolyester and a manufacturing method thereof, and particularly to a high heat resistant and transparent polyethylene terephthalate (PET) copolyester and a manufacturing method thereof.

### Description of Related Art

Generally speaking, the crystallization rate of a polyethylene terephthalate (PET) resin is slower than that of a polybutylene terephthalate (PBT) resin, so that a higher molding temperature and a longer cooling time are required when the PET resin is subjected to an injection processing. Accordingly, the application of the PET resin in engineering plastics is limited. In addition, due to the rigid structure of polyethylene terephthalate (PET), the melting point is high, which in turn leads to high haze in the product.

Therefore, it becomes an important topic in the industry to develop a transparent PET resin with an increased crystallization rate and lower haze, thereby shortening the injection molding time and enhancing transparency and heat resistance, so as to expand the product application.

### SUMMARY

The disclosure provides a polyethylene terephthalate (PET) copolyester and a manufacturing method thereof, in which the PET polymer has the advantages of rapid crystallization rate and high crystallinity, and therefore effectively shortens the injection molding time, and transparency and heat resistance are enhanced.

The disclosure provides a manufacturing method of a polyethylene terephthalate (PET) copolyester that includes the following steps. A dispersion slurry including a talcum powder is formulated. Terephthalic acid and ethylene glycol are mixed, and the dispersion slurry and a side group ester compound are introduced to perform a transesterification reaction and form bis-2-hydroxylethyl terephthalate. Afterwards, a prepolymerization reaction and a polycondensation reaction are carried out to form a polyethylene terephthalate copolyester.

In an embodiment of the present disclosure, the talcum powder has an average particle size of 1.0 μm to 5.0 μm, and an average specific surface area of 20 m²/g to 12 m²/g.

In an embodiment of the present disclosure, the side group ester compound includes 2,6-naphthalene dicarboxylate.

In an embodiment of the present disclosure, based on a total weight of the dispersion slurry, a content of the talcum powder ranges from 1 wt % to 8 wt %.

In an embodiment of the present disclosure, the dispersion slurry further comprises a dispersant and an ethylene glycol, and based on a total weight of the dispersion slurry, a content of the dispersant ranges from 99 wt % to 1 wt %.

In an embodiment of the present disclosure, based on a total weight of the bis-2-hydroxylethyl terephthalate, an added amount of the dispersion slurry ranges from 1 wt % to 6 wt %.

In an embodiment of the present disclosure, during the transesterification reaction, an equivalent ratio of the terephthalic acid to the ethylene glycol ranges from 1/1.2 to 1/1.8, a reaction temperature ranges from 200° C. to 230° C., and a reaction time ranges from 2 hours to 4 hours.

In an embodiment of the present disclosure, based on a total weight of the bis-2-hydroxylethyl terephthalate, an added amount of the side group ester compound is 1 wt % to 5 wt %.

In an embodiment of the present disclosure, during the prepolymerization reaction, reactants comprise the bis-2-hydroxylethyl terephthalate and a polyethylene glycol, wherein based on a total weight of the bis-2-hydroxylethyl terephthalate, a content of the polyethylene glycol ranges from 0.5 wt % to 4 wt %, a reaction temperature ranges from 230° C. to 270° C., a vacuum degree is 760 mmHg to 10 mmHg, and a reaction time ranges from 1 hour to 2 hours.

In an embodiment of the present disclosure, the polycondensation reaction is carried out after the prepolymerization reaction, and during the polycondensation reaction, a reaction temperature ranges from 260° C. to 280° C., a vacuum degree ranges from 1 mmHg to 3 mmHg, and a reaction time ranges from 2 hours to 4 hours.

The disclosure provides a polyethylene terephthalate (PET) copolyester made by the manufacturing method described above.

Based on the above, in the present disclosure, a talc-containing dispersion slurry and a side group ester compound are introduced into the reaction process of manufacturing a PET copolyester. The talcum powder with a small particle size range and a high specific surface area is beneficial to induce the PET nucleation and therefore improve the crystallization rate. In addition, the side group ester compound can enhance transparency and heat resistance and lower haze. The PET copolyester manufactured by the above method can effectively reduce the processing time of injection molding and expand its applicability due to its rapid crystallization and high crystallinity. In, addition, a PET copolyester with high transparency, low haze and better heat resistance can be produced through the above method.

### DESCRIPTION OF THE EMBODIMENTS

Embodiments of the disclosure will be described in details below. However, these embodiments are illustrative, and the disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

The disclosure provides a manufacturing method of a polyethylene terephthalate (PET) copolyester that includes the following steps. A dispersion slurry including a talcum powder is formulated. Terephthalic acid and ethylene glycol are mixed, and the dispersion slurry and a side group ester compound are introduced to perform a transesterification reaction and form bis-2-hydroxylethyl terephthalate. Afterwards, a prepolymerization reaction and a polycondensation reaction are carried out to form a polyethylene terephthalate copolyester. Hereinafter, details of each step will be exhaustively explained.

### Formulation of Dispersion Slurry

In the present embodiment, a dispersion slurry is prepared, and the dispersion slurry includes a talcum powder, and further includes a dispersant and an ethylene glycol (EG), but the disclosure is not limited thereto. Herein, the preparation method of the dispersion slurry includes, for example but not limited to, mixing the talcum powder, the dispersant and the ethylene glycol, and stirring the mixture under ultrasonic vibration at room temperature for 1 hour.

Specifically, the talcum powder may be a superfine talcum powder, and can serve as a nucleating agent. In some embodiments, the shape of talcum powder may have an irregular or round granular structure, the average particle size may range from 1 μm to 5 μm, and the average specific surface area may range from 20 m²/g to 12 m²/g. In some preferred embodiments, the average particle size of the talcum powder may range from 1 μm to 2 μm, and the average specific surface area may range from 20 m²/g to 16 m²/g. The specific surface area of the talcum powder is high due to its small particle size range, which can induce the accelerated nucleation of PET, and therefore increase the crystallization rate of PET.

In some embodiments, based on the total weight of the dispersion slurry, the content of the talcum powder may range from 1 wt % to 8 wt %. In some preferred embodiments, the content of the talcum powder may range from 1 wt % to 6 wt %. In some more preferred embodiments, the content of the talcum powder may range from 1 wt % to 5 wt %. When the content of the talcum powder in the dispersion slurry is greater than 8 wt %, the talc accumulation is likely to occur due to excessive talcum powder. When the content of the talcum powder in the dispersion slurry is less than 1 wt %, it may be difficult to crystallize PET because the content of the talcum powder is too low. When the content of talcum powder is between 1 wt % and 5 wt %, the crystallization rate of PET can be greatly improved.

The dispersant may include a coupling agent containing a hydroxyl functional group, such as hexyltrimethoxysilane; a chelating titanate coupling agent such as bis(octylpyrophosphate)glycolic acid titanate, etc., for dispersing components in the dispersion solution (i.e., dispersion slurry). In some embodiments, based on the total weight of the dispersion slurry, the content of the dispersant may range from 0.2 wt % to 2 wt %. In some preferred embodiments, the content of the dispersant may range from 0.3% to 1.5 wt %. In some more preferred embodiments, the content of the dispersant may range from 0.5% to 1.0 wt %. When the content of the dispersant in the dispersion slurry is greater than 2 wt %, the dispersion uniformity becomes poor, and the reactivity of the polycondensation reaction of a copolyester is deteriorated. When the content of the dispersant in the dispersion slurry is less than 0.2 wt %, the components in the solution may not be effectively dispersed due to the low content of the dispersant, resulting in accumulation phenomenon. When the content of the dispersion is between 0.5 wt % and 1.0 wt %, a good dispersion effect can be achieved.

### Transesterification Reaction

In the present embodiment, a terephthalic acid (PTA) and an ethylene glycol (EG) are mixed, and the dispersion slurry and a side group ester compound are introduced, so as to carry out a transesterification reaction to form a bis-2-hydroxylethyl terephthalate (BHET). The main reactants for the transesterification reaction (that is, the raw materials for the synthesis of bis-2-hydroxylethyl terephthalate) include a terephthalic acid and an ethylene glycol, wherein the equivalent ratio of the terephthalic acid to the ethylene glycol may range from about 1/1.2 to 1/1.8, the reaction temperature may range from about 200° C. to 230° C., and the reaction time may range from about 2 hours to 4 hours. When the reaction conditions are set as above, there is an esterification rate of about 90% to 96%, but the disclosure not limited thereto. The side group ester compound includes 2,6-naphthalene dicarboxylate. The side group ester compound can improve transparency and heat resistance and reduce haze, so as to make PET copolyester with high transparency, low haze and better heat resistance.

Specifically, in this step, the addition of a dispersion slurry and a side group ester compound may be further included, so as to help the nucleation and crystallization stages when forming PET. Based on the total weight of the bis-2-hydroxylethyl terephthalate (BHET), the added amount of the dispersion slurry may range from 2 wt % to 20 wt %, that is, the added amount of the talcum powder may range from about 0.1 wt % to 1 wt %, preferably from about 0.2 wt % to 0.8 wt %, more preferably from about 0.3 wt % to 0.6 wt %. When the added amount of the talcum powder is less than 0.1 wt %, the talcum powder has no effect because the added amount is too small. When the added amount of the talcum powder is greater than 1.0 wt %, the nucleation rate is not greatly improved, and excessive talcum powder affects the reaction rate. When the added amount of talcum powder (or dispersion slurry) falls within the above-mentioned range, the crystallization time of PET can be effectively shortened to increase the crystallization rate.

In this embodiment, based on the total weight of ethylene terephthalate (BHET), the amount of the side group ester compound may be added in an amount of 1 wt % to 5 wt %. When the amount of side group ester compound added is less than 1 wt %, the injection appearance of the finished product is foggy, and the improvement of heat resistance is not obvious. When the addition of side group ester compound is greater than 5 wt %, it will lead to a decrease in the heat distortion temperature of the modified polyester. When the addition amount of the side group ester compound falls within the above-mentioned limited range, the transparency and heat resistance can be improved and the haze can be reduced, so as to produce a PET copolyester with high transparency, low haze and better heat resistance.

### Prepolymerization Reaction and Polycondensation Reaction

Specifically, during the prepolymerization reaction, the reactants may include the bis-2-hydroxylethyl terephthalate (BHET) and a polyethylene glycol (PEG). Based on the total weight of the bis-2-hydroxylethyl terephthalate (BHET), the content of polyethylene glycol (PEG) may range from 0.5 wt % to 4 wt % (preferably from about 1 wt % to 4 wt %), the reaction temperature may range from 230° C. to 270° C., the vacuum degree is slowly reduced to 20 Torr to 10 Torr (i.e., mmHg), and the reaction time may range from 1 hour to 2 hours.

The polycondensation reaction is carried out after the prepolymerization reaction. In this embodiment, during the polycondensation reaction, the reaction temperature may range from 260° C. to 280° C., the vacuum degree may range from 1 Torr to 3 Torr, and the reaction time may range from 2 hours to 4 hours. More specifically, the reaction is ended when the stirring power is increased from 80 watts (w) to 110 watts. The manufacture of a PET copolyester is thus completed.

Generally speaking, in the conventional PET injection processing, there are following problems: (1) terephthalic acid and ethylene glycol are used as raw materials, but the short chain of ethylene glycol is not flexible and therefore the crystallization ability of PET is hindered; and (2) PET has a rigid structure with a high melting point, so a higher temperature is required during the injection molding process, and the product haze is higher. Therefore, the application field of the conventional PET is limited. In the embodiment of the present disclosure, a talc-containing dispersion slurry is added during polymerization, so the small particle size range and the high specific surface area of the talcum powder are beneficial to induce the PET nucleation and therefore improve the crystallization rate. In addition, a side group ester compound is further added during polymerization, it can improve transparency and heat resistance and reduce haze, so as to make PET copolyester with high transparency, low haze and better heat resistance. The PET copolyester produced by the above optimized process has the advantages of rapid crystallization, shortened half-crystallization time, high crystallinity, high transparency, low haze, better heat resistance, and shortened injection molding processing time.

Hereinafter, the PET copolyesters of the present disclosure and manufacturing methods thereof will be described in detail by means of experimental examples. However, the following experimental examples are not intended to limit the present disclosure.

### Experimental Examples

TABLE 1

| | | | Comparative | Example | Example | Example | Example | Example |
|---|---|---|---|---|---|---|---|---|
| | | | Example | 1 | 2 | 3 | 4 | 5 |
| component | bis-2-hydroxylethyl | | 1000 | 1000 | 1000 | 1000 | 1000 | 1000 |
| (g) | terephthalate | | | | | | | |
| | polyethylene glycol | | 10 | 10 | 10 | 10 | 20 | 10 |
| | naphthalene diate ester | | 0 | 20 | 20 | 10 | 20 | 30 |
| | ultrafine talcum Powder | | | 3 | 6 | 6 | 6 | 3 |
| | general talcum powder | | 3 | | | | | |
| physical | heating | glass | 77 | 79 | 79 | 78 | 78 | 80 |
| properties | | transition | | | | | | |
| | | temperature | | | | | | |
| | | (° C.) | | | | | | |
| | | melting point | 255 | 248 | 249 | 251 | 245 | 244 |
| | | (° C.) | | | | | | |
| | cooling | crystallization | 184 | 195 | 199 | 198 | 200 | 193 |
| | | temperature | | | | | | |
| | | (° C.) | | | | | | |
| | | crystallization | 12 | 35 | 37 | 38 | 36 | 33 |
| | | enthalpy (J/g) | | | | | | |

| | | | | | | |
|---|---|---|---|---|---|---|
| supercooling degree | 71 | 53 | 47 | 53 | 45 | 51 |
| (° C.) | | | | | | |
| half-crystallization time | 0.57 | 0.41 | 0.36 | 0.34 | 0.32 | 0.44 |
| (min) | | | | | | |
| viscosity (dl/g) | 0.68 | 0.76 | 0.71 | 0.71 | 0.72 | 0.74 |
| transmittance(%) | 71.2 | 82.6 | 81.2 | 80.1 | 82.4 | 84.2 |
| haze | 42.5 | 13.1 | 17.4 | 20.3 | 18.1 | 11.8 |

As described in above Table 1, Comparative Example does not use naphthalene diate ester and superfine talcum powder of the present invention, therefore, compared with Examples 1 to 5 using naphthalene diate ester and superfine talcum powder of the present invention, the crystallization rate and transparency of Comparative Example are lower and the haze is higher.

In summary, the present invention introduces the dispersion slurry containing talcum powder and the side group ester compound into the reaction process of making PET copolyester, and through the talcum powder with high specific surface area and narrow particle size distribution, PET nucleation can be induced to improve the crystallization rate; in addition, the side group ester compound can improve transparency and heat resistance and reduce haze. The PET copolyester prepared by the above method can effectively reduce the processing time of injection molding and expand its applicability due to its rapid crystallization and high crystallinity. On the other hand, PET copolyester with high transparency, low haze and better heat resistance can be produced through the above method.

Although the present disclosure has been disclosed above with the embodiments, it is not intended to limit the present disclosure. Anyone with ordinary knowledge in the technical field may make some changes and modifications without departing from the spirit and scope of the present disclosure. The scope of protection of the present disclosure should be defined by the scope of the appended patent application.

What is claimed is:

1. A manufacturing method of a polyethylene terephthalate copolyester, comprising:
preparing a dispersion slurry, wherein the dispersion slurry comprises a talcum powder;
mixing a terephthalic acid and an ethylene glycol, and introducing the dispersion slurry and a side group ester compound, so as to carry out a transesterification and therefore form a bis-2-hydroxylethyl terephthalate; and
carrying out a prepolymerization reaction and a polycondensation reaction, so that the bis-2-hydroxylethyl terephthalate forms a polyethylene terephthalate copolyester.

2. The manufacturing method of claim 1, wherein the talcum powder has an average particle size of 1.0 μm to 5.0 μm, and an average specific surface area of 20 m²/g to 12 m²/g.

3. The manufacturing method of claim 1, wherein the side group ester compound includes 2,6-naphthalene dicarboxylate.

4. The manufacturing method of claim 1, wherein based on a total weight of the dispersion slurry, a content of the talcum powder ranges from 1 wt % to 8 wt %.

5. The manufacturing method of claim 1, wherein the dispersion slurry further comprises a dispersant and an ethylene glycol, and based on a total weight of the dispersion slurry, a content of the dispersant ranges from 99 wt % to 1 wt %.

6. The manufacturing method of claim 1, wherein based on a total weight of the bis-2-hydroxylethyl terephthalate, an added amount of the dispersion slurry ranges from 1 wt % to 6 wt %.

7. The manufacturing method of claim 1, wherein during the transesterification reaction, an equivalent ratio of the terephthalic acid to the ethylene glycol ranges from 1/1.2 to 1/1.8, a reaction temperature ranges from 200° C. to 230° C., and a reaction time ranges from 2 hours to 4 hours.

8. The manufacturing method of claim 1, wherein based on a total weight of the bis-2-hydroxylethyl terephthalate, an added amount of the side group ester compound is 1 wt % to 5 wt %.

9. The manufacturing method of claim 1, wherein during the prepolymerization reaction, reactants comprise the bis-2-hydroxylethyl terephthalate and a polyethylene glycol, wherein based on a total weight of the bis-2-hydroxylethyl terephthalate, a content of the polyethylene glycol ranges from 0.5 wt % to 4 wt %, a reaction temperature ranges from 230° C. to 270° C., a vacuum degree is 760 mmHg to 10 mmHg, and a reaction time ranges from 1 hour to 2 hours.

10. The manufacturing method of claim 1, wherein the polycondensation reaction is carried out after the prepolymerization reaction, and during the polycondensation reaction, a reaction temperature ranges from 260° C. to 280° C., a vacuum degree ranges from 1 mmHg to 3 mmHg, and a reaction time ranges from 2 hours to 4 hours.

11. A polyethylene terephthalate copolyester, made by the manufacturing method of claim 1.
